(19) United States
(12) Patent Application Publication
(10) Pub. No.: US 2014/0278656 A1
(43) Pub. Date: Sep. 18, 2014

(54) Service Level Model, Algorithm, Systems and Methods

(71) Applicant: ROTH STAFFING COMPANIES, L.P., Orange, CA (US)

(72) Inventors: Robert Alan Hankin, Dana Point, CA (US); Ben Martin Roth, Fullerton, CA (US)

(73) Assignee: ROTH STAFFING COMPANIES, L.P., Orange, CA (US)

(21) Appl. No.: 13/839,354

(22) Filed: Mar. 15, 2013

(51) Int. Cl. G06Q 10/06

(52) U.S. Cl. CPC G06Q 10/063118
USPC 705/7.17

(57) ABSTRACT

Systems and methods for modeling staffing service levels in a workplace is disclosed. Such a system can include memory that stores instructions and a processor that executes the instructions to perform operations. The operations can include receiving questionnaire responses to a questionnaire that elicits a perception of staffing service level factors of a plurality of representatives, where the questionnaire responses are provided by one of company representatives, company workforce representatives or a combination thereof. The operations can also include selecting questionnaire responses of the representatives, determining an expected staffing service level, calculating representative questionnaire scores, comparing the representative questionnaire scores to a statistical model, and determining a staffing service level tendency based on comparing the representative questionnaire scores to the statistical model, where the staffing service level tendency indicates a likelihood that a maximum staffing service level will at least meet the expected staffing service level given the current circumstances of the company.

### FIELD OF THE INVENTION

The present application generally relates to staffing service levels and more particularly relates to predicting the maximum service levels attainable by a provider of contingent labor for a specific company, under the given circumstances.

### BACKGROUND

Companies often turn to providers of contingent labor, or temporary staff, as customers or clients to address workforce needs that occur from time to time. Contingent labor can include skilled or unskilled workers that can address increases in work volume, desires to complete projects faster or for other reasons. Staffing service level means the measure of the ability of a contingent workforce provider to deliver staffing services to a company pursuant to the company's performance expectations. The performance of providers of contingent labor is often judged by the companies that engage them based on the ability to obtain and retain qualified contingent workforces for specified periods of time. The workforce needs of a company, or a customer or client of a provider of contingent labor, can be based on a variety of factors, including the amount of work to be completed, the amount of time to complete the work and any particularized skill sets needed to complete the work. The term, the length of employment, duration of employment or attrition of contingent workforce members, and even full time workforce members, however, is not uniform.

### SUMMARY

The present application includes systems and methods for predicting the maximum staffing service level attainable by any provider of contingent labor for that particular company given the company's current conditions. With the systems and methods disclosed herein, the contingent workforce provider will be able to identify the areas of opportunity to modify so that the maximum staffing service level attainable can be increased or improved.

Various systems and accompanying methods for modeling staffing service levels are disclosed. The system may enable a provider of contingent workforces to collaborate with clients to predict or calculate the client's maximum attainable level of service from any contingent workforce provider under the company's current circumstances. The system can also determine whether the staffing service level perceptions of the various company management levels, temporary workforce, and full-time workforce, and any other groups or levels at the company, collectively the company's hierarchical levels or groups, meet, exceed, or are below the maximum service level attainable at that company under those current circumstances. The system can also compare the perceptions of each hierarchical group to identify variances between the groups. A value or score can also be calculated for these perceptions. The value or score can be used by a statistical model to predict or calculate tendencies. Further, the value or score can be compared to a plurality of corresponding company values or scores.

The system can use questionnaires that elicit a perception of staffing service level factors according to the perspective of various company representatives. These company representatives can be at different hierarchical levels within a company, including executives, hiring managers, line managers, full-time employees, and temporary employees. The responses to the questionnaires can be scored and compared to both the statistical model and corresponding company values. The statistical model produces or calculates a numeric value representative of the total company, which can be a score, and the model also produces or calculates a score for each hierarchical group. The score is a numeric representation of the expected staffing service level given the company's current conditions. The system can also retrieve an average of the real world staffing metrics and deliverables from a plurality of companies with corresponding scores to provide what typical maximum staffing service levels the company can expect. Which companies are like, similar or corresponding companies can be determined by a selection of matching companies based on a plurality of secondary data variables, such as demographics, industry, geographic region, company size and company function. Other relevant secondary data can also be compared to identify corresponding companies. The system can also map to a database containing a multitude of scores and client staffing metric data.

Staffing service level tendencies as compared to the statistical model can be obtained for each hierarchical group of scores and plausible tendencies can be determined from comparisons of these scores to the model. The hierarchical group of scores is a weighted average of all responses from each hierarchical level at the company. In addition, the overall staffing service level tendency as compared to the statistical model can be obtained for the overall company score and plausible tendencies can be determined from comparisons of this score to the model. The overall company score is a weighted average of all company responses.

By comparing the company's overall score to scores of corresponding companies, based on secondary data variables, a company's maximum staffing service level can be determined. This comparison can also include many secondary data variables, such as demographics, industry, geographic region, company size and company function, that can be used to broaden or limit the scope of the comparison. For example, an overall company score can be compared to other companies within the same city and the same industry that have a similar size. As an alternative example, an overall company score can be compared to other companies within the same industry across multiple cities that have the same city population size.

Further, the systems, methods and models can evolve over time as the questionnaire scores are saved and the model is recalculated over time. The responses to these saved questionnaires can also determine the relevancy of the various questions as they pertain to the model. The relevancy can then influence the weighting of each questionnaire response. This evolution of the model provides for a greater alignment between the model and the predicted or calculated tendencies.

In one embodiment, a system for modeling staffing service levels is provided. The system can include memory that stores instructions and a processor that executes the instructions to perform operations. The operations can include receiving an expected staffing service level, given the company's current conditions from questionnaire responses to a questionnaire that elicits a perception of staffing service level factors of a company representative, where the questionnaire responses are provided by the company representative. Additionally, the operations can also include selecting questionnaire responses of the company representative, calculating a company representative questionnaire score, and comparing the company representative questionnaire score to a statistical model. Further, the operations can include determining a staffing service level tendency based on comparing the company representative questionnaire score to the statistical model, where the staffing service level tendency indicates the likelihood that a rendered service level will at least meet the expected staffing service level. Additionally, the company representative can be an executive level or hiring manager/supervisor employee.

In another embodiment, the operations can include receiving questionnaire responses to the questionnaire that elicits a perception of staffing service level factors of a plurality of company representatives, where the company representatives can be grouped into hierarchical levels or roles within the company. Further, the operations can include selecting a hierarchical grouping of questionnaire responses of the company representatives, calculating a hierarchical group questionnaire score, and comparing the hierarchical group questionnaire score to a statistical model. They can also include determining a staffing service level tendency based on comparing the hierarchical group questionnaire score to the statistical model, where the staffing service level tendency indicates the likelihood that a rendered service level will at least meet the expected staffing service level.

In another arrangement, the operations can also include comparing the hierarchical group questionnaire scores to the questionnaire scores of the one or more other company hierarchical groups. Further, this comparison can include performing a gap analysis of the scores to determine the variance of expected staffing service levels between the hierarchical groups. This analysis can identify areas of opportunity to bring the expected staffing service level of the various hierarchical groups into closer alignment.

Still further, the operations can include receiving questionnaire responses to the questionnaire that elicits a perception of staffing service level factors of contingent or full-time company workforce representatives, where the questionnaire responses are provided by a contingent or full-time company workforce representative. The operations can also include selecting questionnaire responses of the contingent or full-time company workforce representatives, calculating a contingent or full-time company workforce representative questionnaire score, comparing the contingent or full-time company workforce representative questionnaire scores to executive, hiring manager/supervisory or other company representative scores, and determining a tendency based on comparing the contingent or full-time company workforce representative scores to the executive, hiring manager/supervisory or other company representative scores. Additionally, a gap analysis can be performed on the variances between the scores to determine opportunities to bring the expected staffing service level between the contingent or full-time company workforce representatives and the executive, hiring manager/supervisory or other company representatives into closer alignment.

In yet another arrangement, the operations can include updating the corresponding company scores with the questionnaire responses provided by the overall company and recalculating a statistical model based on the updated corresponding company scores. Further, they can include updating the corresponding company scores with the questionnaire responses received from the company representatives and calculating maximum staffing service level averages associated with a range of corresponding company scores. Also, they can include identifying outcome determinative factors from the staffing service level factors, providing suggested changes, in response to identifying outcome determinative factors, to increase the chance that the rendered service level will at least meet the expected staffing service level.

In another embodiment, a method for modeling staffing service levels is provided. The method can include receiving an expected staffing service level from questionnaire responses to a questionnaire that elicits a perception of staffing service level factors of a multitude of company representatives, where the questionnaire responses are provided by the company representatives. The method can also include selecting questionnaire responses of the company representatives, calculating an overall company questionnaire score, comparing the overall company questionnaire score to a statistical model, and determining a staffing service level tendency based on comparing the overall company questionnaire score to the statistical model, where the expected staffing service level tendency indicates a likelihood that a rendered service level will meet or be more or less likely to exceed the average maximum staffing service level.

In another embodiment, a computer-readable device is provided. The computer-readable device can include instructions, which when executed by a processor, cause the processor to perform operations. The operations can include receiving an expected staffing service level from questionnaire responses to a questionnaire that elicits a perception of staffing service level factors of a multitude of company representatives, where the questionnaire responses are provided by the company representatives. The operations can also include selecting questionnaire responses of the company representatives, calculating an overall company questionnaire score, comparing the overall company questionnaire score to a statistical model, and determining a staffing service level tendency based on comparing the overall company questionnaire score to the statistical model, where the expected staffing service level tendency indicates a likelihood that a rendered service level will meet or be more or less likely to exceed the average maximum staffing service level.

These and other features of the systems and methods for modeling staffing service levels are described in the following detailed description, drawings, and appended claims.

### BRIEF DESCRIPTION OF THE DRAWINGS

FIG. 1 is a schematic illustration featuring a view of a system for modeling staffing service levels according to an embodiment of the present disclosure.

FIG. 2 is an exemplary questionnaire that elicits a perception of staffing service level factors of a company representative according to the present disclosure.

FIG. 3 is another exemplary questionnaire that elicits a perception of staffing service level factors of a company representative according to the present disclosure.

FIG. 4 is another exemplary questionnaire that elicits a perception of staffing service level factors of a company representative according to the present disclosure.

FIG. 5 is another exemplary questionnaire that elicits a perception of staffing service level factors of a company representative according to the present disclosure.

FIG. 6 is another exemplary questionnaire that elicits a perception of staffing service level factors of a company representative according to the present disclosure.

FIG. 7 is another exemplary questionnaire that elicits a perception of staffing service level factors of a company representative according to the present disclosure.

FIG. 8 is another exemplary questionnaire that elicits a perception of staffing service level factors of a company representative according to the present disclosure.

FIG. 9 is another exemplary questionnaire that elicits a perception of staffing service level factors of a company representative according to the present disclosure.

FIG. 10 is another exemplary questionnaire that elicits a perception of staffing service level factors of a company representative according to the present disclosure.

FIG. 11 is another exemplary questionnaire that elicits a perception of staffing service level factors of a company representative according to the present disclosure.

FIG. 12 is a flow diagram illustrating a sample method for modeling staffing service levels according to the present disclosure.

FIG. 13 is a flow diagram illustrating a sample method for addressing staffing service levels according to the present disclosure.

FIG. 14 is a diagrammatic representation of a machine in the form of a computer system within which a set of instructions, when executed, may cause the machine to perform any one or more of the methodologies discussed herein.

### DETAILED DESCRIPTION

A system 100 for modeling staffing service levels that are desired by a company and that can be attained by a provider of contingent workforce is disclosed in the present disclosure. Referring to the drawings and in particular to FIG. 1, the system 100 may enable a modeling server 110 to receive and process questionnaire responses from one or more company representatives utilizing one or more devices 120, 130 to input questionnaire responses.

The server or device 110 may include one or more electronic processors 112, which may be configured to handle any necessary processing for carrying out any and all of various operative functions of the system 100. The electronic processors 112 may be software, hardware, or a combination of hardware and software. Additionally, the server 110 may also include a memory 114, which may be configured to store instructions that the electronics processors 112 may execute to perform various the operations of the system 100. For example, the server 110 may receive questionnaire response data from the company representative utilizing handheld device 120 and perform the necessary operations to compare company representative questionnaire scores to a statistical model, determine staffing service level tendencies, compare company representative questionnaire scores to corresponding company scores and other operations and functions discussed herein.

In one embodiment, multiple servers or devices 110 may be utilized to process the functions of the system 100. The server 110 or the device 110, or both, may utilize the database 140 for storing a plurality of stored previous company responses, previous calculations and corresponding company staffing service levels, along with any other data that the devices in the system 100 may utilize in processing. In an embodiment, multiple databases 140 may be utilized to store data in the system 100. Notably, the system 100 may utilize a combination of software and hardware to perform the operative functions of the system 100 disclosed herein. Additionally, although FIG. 1 illustrates specific example configurations of the various components of the system 100, the system 100 may include any configuration of the components, which may include using a greater or lesser number of the components.

Furthermore, the communications network 135 may be any suitable network that may be utilized to allow the various components of the system 100 to communicate with one another. For instance, the communications network 135 may be a wireless network, an ethernet network, a satellite network, a broadband network, a cellular network, a private network, a cable network, the Internet, or any combination thereof.

The system and methods disclosed herein relate to modeling staffing service levels that will likely be rendered under a set of given circumstances. The modeled staffing service level, which is the maximum staffing service level that can be achieved by a contingent workforce given the company's current circumstances, may differ from a company's or client's expected staffing service level. The maximum staffing service level may differ for any particular client, and there can be company or client specific criteria or criterions used to determine whether a contingent workforce provider met the client's staffing needs. Thus, the maximum staffing service level can be the ability of a provider of contingent workforce, or a staffing company, to meet certain criteria. Accordingly, the maximum staffing service level may include the ability of the contingent workforce provider to deliver or obtain the client's desired number of contingent employees for a particular assignment or project. The maximum staffing service level may also include the ability of the contingent workforce provider to deliver or obtain the client's desired contingent employees with appropriate skill or experience levels for a particular assignment or project. The maximum staffing service level may also include the ability of the contingent workforce provider to deliver or obtain the contingent employees consistent with a timeline established by the client. The maximum staffing service level may also include the ability of the contingent workforce provider to maintain the contingent employees for the duration of a particular assignment. The maximum staffing service level may also include the ability of the contingent workforce provider to deliver any combination of the above.

The system and methods disclosed herein include questionnaires and responses to the questionnaires from one or more company representatives. The questionnaires can include a variety of questions that relate to, and that do not relate to, a company representative's perception of staffing service level factors. One or more combinations of the staffing service level factors can be determinative of whether the contingent labor provider will be able to meet or exceed the client's expected staffing service level. The staffing service level factors may include employee work conditions, staffing level needs, employee satisfaction and other issues. Available answers to the individual questions within the questionnaire can include a numerical rating scale, such as a Likert-type scale. Answers to the individual questions within the questionnaire can also be numerical responses to questions, such as the number of average temporary employees or the average staffing service level. Further, answers to the individual questions within the questionnaire can include a ranking of order of importance of two or more pre-defined answers. Still further, answers to the individual questions within the questionnaire can include the selection of a single most accurate non-numerical answer from a list of possible non-numerical answers.

FIGS. 2-5 are exemplary questions and/or statements of questionnaires that are designed to illicit a perception of staffing service level factors of a company representative. The questions, however, are not limited to being designed to illicit a perception of staffing service level factors. For example, some questions can be included to determine a company representative's, or a client's, service level expectations. Other questions can be included to determine current demographic data. Other questions not related to staffing service levels can also be included.

As shown in FIGS. 2-4, the questions can include statements regarding staffing service level factors. The staffing service level factors may include topics related to work conditions, including an employer's perception of partnering with a contingent workforce provider, the effect of a deficit in the desired number of temporary employees, the benefits provided by the employer, employee satisfaction and other factors.

The available answers to the statements in FIGS. 2-4 include a ranking from 1-10 to indicate the company representative's agreement or disagreement with the statement. The company representative's response can include the degree to which the company representative agrees or the degree to which the company representative disagrees with the statement. For example, if the company representative strongly disagrees with the statement, the company representative can select the first response with a value of one. On the other hand, if the company representative strongly agrees with the statement, the company representative can select the response with a value of 10. The company representative can also select “Don't Know Answer” to indicate that the company representative does not know the answer to the question or statement. In one embodiment, the exemplary questionnaire can be implemented via a web page with appropriate toggle or radio buttons or the like for the company representative to select their answers to the individual questions. The answers can then be received by, for example, a webserver.

FIG. 5 includes additional statements regarding a category of staffing service level factors related to turnover propensity. The turnover propensity statements can provide insight into the likelihood that one or more temporary employees will not complete the intended or anticipated duration of temporary employment. The available answers to the statements in FIG. 5 include a ranking from 1-10 to indicate the company representative's agreement or disagreement with the statement. The company representative's response can include the degree to which the company representative agrees or the degree to which the company representative disagrees with the statement. Other exemplary questions or statements can include the following: temporary employees are treated with the same respect as full-time employees; employees would say we provide an excellent physical work environment; employees would say they love working at our company; there are opportunities for a temporary employee to transition to a full-time position; employees would describe our company policies as very fair; our corporate work culture brings out the best in all of our employees; the greatest demand skill set is highly sought in our geographic region; temporary employees are fully equipped with the right training and materials to perform their job well; temporary employees feel genuinely cared for; there are opportunities for temporary employees to receive individual recognition for excellent performance; temporary employees receive feedback to help improve their performance; our current temporary turnover level is reasonable and acceptable; our temporary employee turnover rate is lower than similar companies in the area; and pay rates for temporary employees similar to similar companies. Any combination of such questions may be utilized.

In one embodiment, the exemplary questionnaire can be implemented via a web page with appropriate toggle or radio buttons or the like for the employer representative to select their answers to the individual questions. The answers can then be received by, for example, a webserver.

FIG. 6 illustrates additional exemplary questions for use in a questionnaire. The questions of FIG. 6 and its format for providing an answer are designed to elicit a numerical response to be provided by a user. For instance, the questions elicit the number of average temporary employees from an employer representative and the number of days of the typical length of a temporary assignment. Again, the exemplary questionnaire can be implemented via a web page with appropriate fields or the like for the employer representative to input their answers to the individual questions. The answers can then be received by, for example, a webserver.

FIG. 7 illustrates a different embodiment of an additional exemplary question for use in a questionnaire. The questions of FIG. 7 include a list of possible answers that reflect an company representative's perception of average length of temporary employee employment and whether such employment is continuous or intermittent. Other questions with pre-populated answers can also be included. The exemplary questionnaire can be implemented via a web page with appropriate fields or the like for the company representative to input their answer(s) to the individual question(s). The answers can then be received by, for example, a webserver.

FIG. 8 illustrates yet another embodiment of an additional exemplary question for use in a questionnaire. The question of FIG. 8 includes a “yes” or “no” answer for selection by the company representative as their answer to the question. Other questions with “yes” or “no” answers, or “true” or “false” answers can also be provided. The exemplary questionnaire can be implemented via a web page with appropriate fields or the like for the employer representative to input their answer(s) to the individual question(s). The answers can then be received by, for example, a webserver.

FIG. 9 illustrates yet another embodiment of an additional exemplary question for use in a questionnaire. The question of FIG. 9 is formatted to elicit a numerical value for the percentage of employees working at a particular employer during a particular shift. For instance, the employer representative can provide answers of 5%, 25%, 0% and 30%, respectively, for the first, second, third shift and total. The exemplary questionnaire can be implemented via a web page with appropriate fields or the like for the company representative to input their answer(s) to the individual question(s). The answers can then be received by, for example, a webserver.

FIG. 10 illustrates yet another embodiment of an additional exemplary question for use in a questionnaire. The question of FIG. 10 is formatted to elicit a ranking of three qualities of importance to selecting a staffing partner. The factors are provided and the company representative can provide a ranking of first, second and third as appropriate. Again, the exemplary questionnaire can be implemented via a web page with appropriate fields or the like for the company representative to input their answer(s) to the individual question(s). The answers can then be received by, for example, a webserver.

FIG. 11 illustrates an exemplary conclusion page to the questionnaire. The exemplary conclusion page illustrates that the questionnaire can be implemented via a web page and the employer representative can conclude the questionnaire by selecting the submit button. At this time, all of the company representative's answers can be submitted and then received, for example, via a web server. Alternatively, the answers can be submitted and received as soon as they are input by the employer representative.

One embodiment of a method for a modeling staffing service level of a company seeking one or more temporary or contingent employees is illustrated in FIG. 12 as a flow diagram. The method 1200 for modeling a staffing service level can start at 1210. At step 1220, responses to one or more questionnaires can be received from one or more of company and company workforce representatives. The responses can be formatted in a data structure, such as utilizing extensible mark-up language, suitable for parsing the responses to individual questionnaire questions. The questionnaire can include any one or more combinations of the exemplary questions from FIGS. 2-11.

Step 1220 can be repeated one or more times to receive responses to a questionnaire from a plurality of company and company workforce representatives. Step 1220A represents an example of receiving one or more questionnaire responses from representatives of a company's executive leadership team, such as presidents and officers. Step 1220B represents an of receiving one or more questionnaire responses from representatives of a company's hiring managers or supervisors. Step 1220C represents an example of receiving one or more questionnaire responses from representatives of a company's full-time workforce. Step 1220D represents an example of receiving one or more questionnaire responses from representatives of a company's contingent workforce. Step 1220E represents an example of receiving one or more questionnaire responses from any other type of company or company workforce representative. Further, steps 1220A-E can be grouped by hierarchical level within the company. In addition to individual representative scores, each hierarchical group can have a questionnaire score by averaging the scores from a particular hierarchical group. Further still, all responses can be grouped together to create an overall company score. The system and method are not limited in the number of company or permanent or temporary workforce representatives from which questionnaire responses can be received. Of all the responses received, certain questionnaire responses can be selected, which can include all of the responses received.

At step 1230, all questionnaire responses received are imported for analysis with a statistical system or software, such as SPSS Predictive Analytics software. This process can utilize a webserver, outputting a formatted data structure from a database containing all questionnaire responses, such as utilizing extensible mark-up language or a comma-separated values file, for utilization by the statistical system or software.

Step 1240A is an example of where a hierarchical group's questionnaire score can be calculated. The calculation can include any appropriate formulae for providing one or more numerical values based on the answers to the questionnaire. As an example, the calculation can be the summation of the numerical values selected by the company representative or grouping of company representatives, where any non-numerical answers are correlated to a numerical value, for instance, on a scale of 1-10. Thus, in some instances, a hierarchical group's questionnaire score can be based on the answers of a single representative. Also, if the score of more than one company representative is utilized, the scores can be averaged by the number of company representative scores that is utilized.

Alternatively, the calculation can be provided via SPSS Predictive Analytics software. A correlation analysis may be performed to look for a relationship between the staffing service level factors. A multivariate regression allowing for multiple dependent variables may be completed using a variety of statistical techniques to identify certain service level factors that uniquely and significantly contribute to the formula. Once the staffing service level factors for the model are selected, the individual regression coefficients may be determined using the least squared method. With the staffing service level factors for the model, a factor analysis may be performed to identify groupings of variables or staffing service level factors and the associated factor loadings. A statistical staffing service level factor is constructed from groupings of variables with interdependent variability. Factor loadings are coefficients where the squared factor loadings show the percent of variance in that indicator variable explained by the factor. The processor and memory may be configured to utilize the following exemplary algorithms to calculate the score.

Correlation Analysis:

$${s}_{x}^{2} = \frac{\sum {x}^{2} - \frac{{( \sum x )}^{2}}{n}}{n - 1} = \frac{SS ( x )}{n - 1}$$

Mulitvariate Regression Model:

Y′i=b0+b1×li+b2×2i+ . . . bn×ni

Least Squares Model:

$$f ( {x}_{i} , β ) = {\sum }_{j = 1}^{m} {β}_{j} {φ}_{j} ( {x}_{i} )$$

where the coefficients, φⱼ, are functions of χᵢ.

Letting

$${X}_{ij} = \frac{\partial f ( {x}_{i} , β )}{\partial {β}_{j}} = {φ}_{j} ( {x}_{i} ) .$$

where: \hat{β}=(X^{T}X)⁻¹X^{T}y.

A matrix based on N observations of responses to questionnaire questions correlated to observed staffing service levels from past engagements can be used to identify determinative service level factors.

At step 1250, the representative questionnaire scores of steps 1240A-B can be compared to a statistical model that provides statistics of service levels, either rendered or expected, or both, of past rendered services or past questionnaire scores. The statistical model can be segregated into a plurality of statistical model scores correlated to demographic data, such as average income, average education, and the unemployment rate, availability of employees based on the job/industry, total population in the geographic area of the client, how many companies in the area are similar to the client (e.g. classified by NAICS code). The demographic data can be based on geography, industries or other categories. Thus, there can be a plurality of statistical model scores correlated to industry, geographic region or other correlation. The aggregation of the statistical model scores can produce a statistical model average score for any correlation chosen. Further, the statistical model average score can also be correlated to the title or level of the company representatives, or hierarchical groupings (e.g., statistical model averages for CEOs, CFOs, etc.) such that different statistical model average scores can be calculated based on the title or level of the company representatives or hierarchical groupings that answered the questionnaire.

In comparing the hierarchical or overall company questionnaire scores of steps 1240A-B to the appropriate statistical model average score, the hierarchical or overall company questionnaire scores can be greater than or less than the statistical model average score. The hierarchical or overall company questionnaire score being greater than or less than the statistical model average score can indicate staffing service level tendency as determined in step 1260.

In step 1260, and based on comparing the hierarchical or overall company questionnaire scores to the appropriate statistical model average, a staffing service level tendency can be determined. The staffing service level tendency can indicate the likelihood that a maximum staffing service level by a provider of contingent workforce will at least meet the expected staffing service level of the company given the company's current circumstances. The tendency can also indicate if the level of services that will or are likely to be rendered will be below, at or above the expected staffing service level. For instance, if the hierarchical or overall company questionnaire score is greater than the statistical model average, the difference between the hierarchical or overall company questionnaire score and the statistical model average can be used to determine a staffing service level tendency. Accordingly, the staffing service level tendency can be a percentage of likelihood that the maximum staffing services levels will be deficient, at or exceed expected staffing service levels. For instance, if the statistical model average score for the chosen corresponding company variables is 75 and the hierarchical or overall company questionnaire score is 82, the difference between the two is 7. The difference of 7 can be used to calculate a certain percentage likelihood that the expected staffing service level will be met.

With the staffing service level tendency determined, the method can end at step 1260. Nevertheless, the hierarchical or overall company questionnaire score can also be saved in step 1265A shown as breakout reference 1. Also, each representative score can be saved over time to continuously build a database of scores. Alternatively, only selected representative scores can be saved over time for inclusion with the database of scores. With each new company or company workforce representative questionnaire score, the model average can be recalculated in step 1265B. Again, there can be one or more statistical model average scores based on, for example, demographic data, and a particular statistical model average score can be recalculated when a representative score that is correlated to the particular demographic data is calculated.

The method can also include comparing hierarchical or overall company questionnaire scores to scores of corresponding companies in step 1270. The comparison can include identifying corresponding companies with the same score as the hierarchical or overall company questionnaire score, or scores within a standard deviation. For instance, scores within a standard deviation value of 1, 2, 3 or so on can be considered similar. The corresponding company scores can also be segregated into a plurality of corresponding company scores correlated to demographic data, such as average income, average education, and the unemployment rate, availability of employees based on the job/industry, total population in the geographic area of a respective client, how many companies in the area are similar to the client (e.g. classified by NAICS code). The demographic data can be based on geography, industries or other categories. Thus, there can be a plurality of corresponding company scores correlated to industry, geographic region or other correlation. The term corresponding to describe this correlation. For example, a corresponding company score can be specific to a particular industry such that different industries can have different corresponding company scores. Further, the corresponding company scores can also be correlated to the title or level of the company representatives, or hierarchical groupings (e.g., statistical model averages for CEOs, CFOs, etc.) such that different corresponding company scores can be calculated based on the title or level of the company representatives or hierarchical groupings that answered the questionnaire.

At step 1280, and based on comparing the hierarchical group or overall company questionnaire score to the scores of corresponding companies of step 1270, a maximum staffing service level can be determined. The maximum staffing service level is based on actual staffing service levels rendered in the past and staffing metrics of the past. The hierarchical group or overall company questionnaire score can be compared to corresponding company scores and the actual rendered staffing service levels and staffing metrics for each corresponding company can be obtained. The maximum staffing service level is a plausible service level that will be rendered based on a correlation to actual past service levels with the same representative or hierarchical scores or representative or hierarchical scores within a standard deviation.

The maximum staffing service level can be determined by selecting an average maximum staffing service level from plausible staffing service level averages associated with a range of corresponding company scores. For instance, the corresponding company scores can be provided in ranges correlated to actual past staffing service level averages. Thus, the maximum staffing service levels can be correlated to actual staffing service levels from past projects or engagements. As an example, the corresponding company scores may indicate that the average maximum staffing service level associated with scores in the range of scores of 70-75 are correlated to an average maximum staffing service of 80. The range can be smaller, such that each range is a single score or unit, and the range can be greater, such as range of 10 or 15 or even higher.

With the average maximum staffing service level determined, the method can end. However, the method can also provide the hierarchical group or overall company questionnaire score along with staffing metrics data from an entity resource planning database of actual or rendered staffing service levels associated with the hierarchical group or overall company questionnaire score. The combination of the hierarchical group or overall company questionnaire score and the rendered staffing service level associated with the hierarchical group or overall company questionnaire score can be input into a database of corresponding company scores. The average maximum staffing service level for the range of corresponding company scores can be updated over time in process 1285A-B as the actual or rendered staffing service level data is correlated to the hierarchical group or overall company questionnaire scores. The updated average maximum staffing service level data can be used for the next determination of a maximum staffing service level average.

As indicated above, the system and method is arranged such that more than one company representative score can be received and used. In the discussion above, an executive level company representative's questionnaire responses can be received at step 1220A. For instance, the executive level can be a CEO, CFO or generally any employee that can sign a contract for the employer to partner with a staffing company.

On the other hand, the method also includes receiving questionnaire responses from a other company representatives, such as at step 1220B, where a non-executive level employee of the company, in this case a hiring manager or supervisor responds to the questionnaire. Generally, the hiring manager or supervisor would be an employee who is in immediate contact with or will otherwise work directly with temporary employees or staff.

The method also includes receiving questionnaire responses from a temporary staff or contingent workforce representative at step 1220D, where the temporary staff or contingent workforce representative is not a full-time employee of the company but is a temporary employee or contingent worker.

The questionnaire for the questionnaire responses received at step 1220D can be the same as, or different than the questionnaire for other company representatives discussed above. Nevertheless, the format of the questions will be the same such that a score can be calculated in step 1240A-B. Just like above, one or a combination of the questions from the questionnaire can be selected for use in the calculation step 1240A-B.

In step 1240A-B, the contingent workforce representative questionnaire score can be calculated. Again, the calculation is the same calculation discussed above with respect to step 1240A-B.

Moving to step 1250, the contingent workforce representative questionnaire score can be compared to a statistical model average score. The statistical model average score can be a single statistical model average score for the method, or as discussed above, the statistical model average score can be a statistical model average score correlated to the type of temporary staff or contingent worker providing responses, by demographics, skill set, length of temporary employment, or another correlation, to the questionnaire.

Again, based on a comparison of the contingent workforce representative questionnaire score to a statistical model average score, a staffing service level tendency can be determined in step 1250.

In instances where a plurality of hierarchical groups of company and/or company workforce representatives respond to the questionnaire, a comparison of the scores between the groups, as seen in step 1260, can also be performed. This comparison can determine tendencies, or percentage likelihoods, or variances between the staffing service level expectations of the various company hierarchical groups. These tendencies or variances can be used to trigger communications and promote dialog concerning a contingent staffing engagement or can influence, or can be used to alter, determinative factors that can affect the maximum staffing service level.

The questionnaire for the questionnaire responses received at steps 1220A-E can be the same as, or different than the questionnaires for the other company or company workforce representatives. Nevertheless, the format of the questions will be the same such that a score can be calculated in step 1240A-B. Just like above, one or a combination of the questions from the questionnaire can be selected for use in the calculation step 1240A-B.

In step 1280, an average maximum staffing service level can be determined by selecting from any combination or groupings on questionnaire responses. Alternatively, a plurality of the determined maximum staffing service levels can themselves be averages to determine a combined average maximum staffing service level. The average maximum staffing service level can provide a benchmark against which the expected staffing service levels can be managed as discussed below.

The calculations and determinations can be utilized to increase service levels as shown in the method 1300. In step 1310, as also discussed above with reference to method 1200, questionnaire responses can be received from one or more company representatives. An example would be the partners of a law firm answering the questions as it relates to their contingent workforce needs. Questionnaire responses could be received from a partner of the law firm as a company representative. Once questionnaire responses are received, one or more of the calculations or determinations discussed with respect to FIG. 12 can be obtained.

At step 1320, after the questionnaire responses have been received from step 1310, the responses can be scored based on the statistical model as discussed above. The scores may then be used to determine the company representative's staffing services level expectations. Likewise, using the law firm example, all partners of the firm can provide questionnaire responses in step 1310 and can be grouped by their hierarchical level. The hierarchical group questionnaire responses can be scored based on the statistical model, determining the hierarchical groups expected staffing service level. Likewise again, this process can be repeated for all hierarchical groups at the firm, which can be used to create an overall firm or company score. This overall company score can be used to determine an overall company staffing service level expectation.

At step 1330, maximum staffing service levels can be determined. As noted previously, the maximum staffing service level can be the ability of a provider of contingent workforce, or a staffing company, to meet certain criteria. For instance, a company that engages a contingent workforce provider can indicate that they seek a certain number of employees with a certain skill level for a project time period that starts on a certain day. Using the example above, the law firm could request a contingent workforce provider to provide 10 staff attorneys with contract drafting experience for a six month project that starts within one month. The maximum staffing service level includes not just whether the staff attorneys meet the initial requirements, but whether they remain on the project for the duration of the project. With the maximum staffing service levels determined in step 1330, differences between company staffing service level expectations and the maximum staffing service level achievable given the company's current circumstances can be determined. The differences may be great or small.

At step 1340, one or more factors that are determinative of the difference between the expected staffing service level and the maximum staffing service can be identified. The determinative factors can be any one or more of the staffing service level factors. As non-limiting examples, the determinative factors may be: whether if all of the temporary positions are not filled, it has a significant impact on the company's ability to accomplish its goals; whether the internal hiring procedures create barriers that influence staffing processes; whether the staffing provider is able to meet all of the company's staffing needs; whether temporary employees are treated with the same respect as full-time employees; and/or pay rates for temporary employees compared to similar companies. The determinative factors can be identical to one or more of the questions in the questionnaires. Alternatively, the determinative factors can be a factor or circumstance derived from one or more staffing service level factors from the questionnaire. The determinative factors may also be related to demographic data, such as demographic data for a particular region. The determinative factors can be identified by statistically analyzing the questionnaire responses with respect to the data of corresponding companies. For example, corresponding company data may be staffing metrics of a company with variables similar to the client with a similar maximum staffing service level or similar staffing service level expectation. These metrics may include observed average length of assignment or turnover reasons. Numerical analyses can be performed to identify one or more factors that are outcome determinative.

At step 1350, and based on the identification of determinative factors, the maximum staffing service level can be increased to meet or exceed the expected staffing service level. Additionally, the staffing service level can increase relatively by the expected staffing service level being influenced based on the identification of determinative factors. For instance, if a determinative factor for the maximum staffing service level is the pay rate for temporary employees compared to corresponding companies, and the pay rate is identified as lacking in comparison to corresponding companies, the pay rate can be increased. As another example, a determinative factor for the maximum staffing service level is whether temporary employees are treated with the same respect as full-time employees, the contingent workforce provider and the client can cooperate to ensure that temporary employees are treated with the same respect as full-time employees. Thus, in response to identifying outcome determinative factors, suggested changes can be provided by the contingent workforce provider to the company. The suggested changes can include a report format listing the outcome determinative factor. The report can also include an indication of the impact of the outcome determinative factor on the maximum staffing service level. Addressing these particular critical factors in these manners can ensure that the maximum staffing service level meets or exceeds the expected staffing service level.

It is important to note that the methods described above may incorporate any of the functionality, devices, and/or features of the systems described above, or otherwise, and are not intended to be limited to the description or examples provided herein.

Referring now also to FIG. 14, at least a portion of the methodologies and techniques described with respect to the exemplary embodiments can incorporate a machine, such as, but not limited to, computer system 1400, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100.

In some embodiments, the machine operates as a standalone device. In some embodiments, the machine may be connected (e.g., using a network 135) to and assist with operations performed by other machines, such as, but not limited to, the device 110, the server 140, the database 145, or any combination thereof. The machine may be connected with any component in the system 100. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 1400 may include a processor 1402 (e.g., a central processing unit (CPU), a graphics processing unit (GPU, or both), a main memory 1404 and a static memory 1404, which communicate with each other via a bus 1408. The computer system 1400 may further include a video display unit 1410 (e.g., a liquid crystal display (LCD), a flat panel, a solid state display, or a cathode ray tube (CRT)). The computer system 1400 may include an input device 1412 (e.g., a keyboard), a cursor control device 1414 (e.g., a mouse), a disk drive unit 1416, a signal generation device 1418 (e.g., a speaker or remote control) and a network interface device 1420.

The disk drive unit 1416 may include a machine-readable medium 1422 on which is stored one or more sets of instructions 1424 (e.g., software) embodying any one or more of the methodologies or functions described herein, including those methods illustrated above. The instructions 1424 may also reside, completely or at least partially, within the main memory 1404, the static memory 1406, or within the processor 1402, or a combination thereof, during execution thereof by the computer system 1400. The main memory 1404 and the processor 1402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium 1422 containing instructions 1424 so that a device connected to the communications network 135 can send or receive voice, video or data, and to communicate over the network 135 using the instructions. The instructions 1424 may further be transmitted or received over the network 135 via the network interface device 1420.

While the machine-readable medium 1422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. In one embodiment, the machine readable storage medium may be a machine readable storage device. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. A system for modeling staffing service levels, comprising:
a memory that stores instructions; and
a processor that executes the instructions to perform operations, the operations comprising:
receiving questionnaire responses to a questionnaire that elicits a perception of staffing service level factors of a plurality of representatives, wherein the questionnaire responses are provided by one of company representatives, company workforce representatives or a combination thereof;
selecting questionnaire responses of the representatives;
determining an expected staffing service level;
calculating representative questionnaire scores;
comparing the representative questionnaire scores to a statistical model; and
determining a staffing service level tendency based on comparing the representative questionnaire scores to the statistical model, wherein the staffing service level tendency indicates a likelihood that a maximum staffing service level will at least meet the expected staffing service level.

2. The system of claim 1, wherein the company representative can be selected from the group consisting of an executive level employee, a hiring manager, and a supervisor; and
wherein the company workforce representative can be selected from the group consisting of a contingent employee and a full-time employee.

3. The system of claim 2, wherein the operations further comprise:
receiving questionnaire responses to the questionnaire that elicits a perception of staffing service level factors of a hierarchical group of company representatives, wherein the questionnaire responses are provided by a plurality of company representatives;
selecting questionnaire responses of the hierarchical group of company representatives;
determining an expected staffing service level for the hierarchical group;
calculating a hierarchical group questionnaire score;
calculating an overall company questionnaire score;
comparing the hierarchical group questionnaire score and overall company questionnaire score to a statistical model; and
determining a staffing service level tendency based on comparing the hierarchical group questionnaire score and overall company questionnaire score to a statistical model, wherein the staffing service level tendency indicates a likelihood that a maximum staffing service level will at least meet the expected staffing service level.

4. The system of claim 3, wherein the operations further comprise:
comparing the overall company questionnaire score to corresponding company scores; and
determining a maximum staffing service level based on comparing the overall company questionnaire score to corresponding company scores.

5. The system of claim 4, wherein determining a maximum staffing service level further comprises selecting an average maximum staffing service level from possible maximum staffing service level averages associated with a range corresponding company scores.

6. The system of claim 5, wherein the maximum staffing service level is a staffing service level that will likely be rendered given current circumstances of the company.

7. The system of claim 1, wherein the operations further comprise updating the statistical model based on a recalculation utilizing the company representative questionnaire score.

8. The system of claim 1, wherein the operations further comprise updating the statistical model based on a recalculation utilizing the calculated hierarchical group questionnaire score and the calculated overall company questionnaire score.

9. The system of claim 4, wherein the operations further comprise:
updating the corresponding company scores with the questionnaire responses received from the company representative; and
recalculating the statistical model based on the updated corresponding company scores.

10. The system of claim 4, wherein the operations further comprise:
updating the corresponding company scores with the calculated hierarchical group questionnaire score and the calculated overall company questionnaire score; and
calculating possible maximum staffing service level averages associated with a range of corresponding company scores.

11. The system of claim 1, wherein the operations further comprise:
identifying outcome determinative factors from the staffing service level factors;
providing suggested changes, in response to identifying outcome determinative factors, to increase the chance that the maximum staffing service level will at least meet the expected staffing service level.

12. A method for modeling staffing service levels, comprising:
receiving questionnaire responses to the questionnaire that elicits a perception of staffing service level factors of a hierarchical group of company representatives, wherein the questionnaire responses are provided by a plurality of company representatives and wherein the company representative can be selected from the group consisting of an executive level employee, a hiring manager, and a supervisor;
selecting questionnaire responses of the hierarchical group of company representatives;
determining an expected staffing service level for the hierarchical group;
calculating a hierarchical group questionnaire score;
calculating an overall company questionnaire score;
comparing the hierarchical group questionnaire score and overall company questionnaire score to a statistical model; and
determining a staffing service level tendency based on comparing the hierarchical group questionnaire score and overall company questionnaire score to a statistical model, wherein the staffing service level tendency indicates a likelihood that a maximum staffing service level will at least meet the expected staffing service level.

13. The method of claim 12, further comprising:
comparing the overall company questionnaire score to corresponding company scores; and
determining a maximum staffing service level based on comparing the overall company questionnaire score to corresponding company scores.

14. The method of claim 12, further comprising:
identifying outcome determinative factors from the staffing service level factors;
providing suggested changes, in response to identifying outcome determinative factors, to increase the chance that the maximum service level will at least meet the expected staffing service level.

15. The method of claim 12, wherein calculating a hierarchical group questionnaire score includes calculating a plurality of hierarchical group questionnaire scores for a plurality of hierarchical groups;
further comprising comparing the hierarchical group questionnaire scores; and
determining a variance between the hierarchical group questionnaire scores.

16. A computer-readable medium comprising instructions, which when executed by a processor, cause the processor to perform operations comprising:
receiving questionnaire responses to the questionnaire that elicits a perception of staffing service level factors of a hierarchical group of company representatives, wherein the questionnaire responses are provided by a plurality of company representatives and wherein the company representative can be selected from the group consisting of an executive level employee, a hiring manager, and a supervisor;
selecting questionnaire responses of the hierarchical group of company representatives;
determining an expected staffing service level for the hierarchical group;
calculating a hierarchical group questionnaire score;
calculating an overall company questionnaire score;
comparing the hierarchical group questionnaire score and overall company questionnaire score to a statistical model; and
determining a staffing service level tendency based on comparing the hierarchical group questionnaire score and overall company questionnaire score to a statistical model, wherein the staffing service level tendency indicates a likelihood that a maximum staffing service level will at least meet the expected staffing service level.

17. The computer-readable medium of claim 16, wherein the operations further comprise:
comparing the overall company questionnaire score to corresponding company scores; and
determining a maximum staffing service level based on comparing the overall company questionnaire score to corresponding company scores;
wherein determining a maximum staffing service level further comprises selecting an average maximum staffing service level from possible maximum staffing service level averages associated with a range corresponding company scores;
wherein the maximum staffing service level is a staffing service level that will likely be rendered given the company's current circumstances.

18. The computer-readable medium of claim 16, wherein the operations further comprise:
identifying outcome determinative factors from the staffing service level factors;
providing suggested changes, in response to identifying outcome determinative factors, to increase the chance that the maximum service level will at least meet the expected staffing service level.
